(19) United States
(12) Patent Application Publication
(10) Pub. No.: US 2004/0246349 A1
(43) Pub. Date: Dec. 9, 2004

(54) Photographing apparatus for automatically setting resolution and method thereof

(76) Inventors: Yong-ho Kim, Seoul (KR); Yong-hyun Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/855,721

(22) Filed: May 28, 2004

(30) Foreign Application Priority Data
Jun. 3, 2003 (KR) 2003-35770

(51) Int. Cl. H04N 5/93

(52) U.S. Cl. 348/231.99

(57) ABSTRACT

A photographing apparatus capable of automatically setting a resolution and a method thereof. The photographing apparatus has a digital video camera unit to photograph a motion picture, a DVC signal processing block, first and second resolution converting units to convert the digital motion picture data to first and second resolutions, respectively, first and second compressing units to compress the output data from the first and second resolution converting units to first and second format data, first and second recording media to store first and second format data, respectively, a recording medium selecting switch to select one among the first and second recording media, and a control unit to control such that the digital motion picture data can be transmitted to one among the first and second resolution converting units. Accordingly, the memory space of the recording medium can be used efficiently, and the user is not inconvenienced by having to set the resolution every time he/she selects the recording medium to use.

This application claims the benefit of under 35 U.S.C. § 119(a) of Korean Patent Application No. 2003-35770 filed Jun. 3, 2003, in the Korean Intellectual Property Office, the disclosure of which is incorporated herein by reference in its entirety.

### BACKGROUND OF THE INVENTION

1. Field of the Invention

The present invention relates to a photographing apparatus and a method thereof. More particularly, the present invention relates to a photographing apparatus capable of automatically setting the resolution of an image in accordance with the type of recording media selectable by a user, and a method thereof.

2. Description of the Related Art

Generally, a digital still camera (DSC) converts an image viewed through a lens into a digital signal, and stores the digital signal in a recording media such as a hard disk or a memory card. Instead of recording the image on film, the DSC can store the image on the recording media and input the digital image directly into the computer, without having to use devices such as a scanner. Since DSCs are highly compatible with personal computers (PC), the DSC enables easy editing or correction. In addition, the DSC is connectible to an external computer to transmit the captured images. Further, being almost in the same structure as general cameras, the DSC is convenient to carry. The DSC mainly includes a lens device, a memory device, a signal converter and a display. However, due to limitations in the memory capacity of recording media, the DSC is usually used for capturing still images. Although the DSC is capable of capturing motion pictures, motion pictures require extensive storage, and therefore only a very limited time can be stored on current memory devices. Therefore, the DSC is not effective for capturing motion pictures. Besides, since many DSCs do not have any device to record and reproduce sound, it is somewhat ineffective to use the DSC for motion picture recording/reproducing. In order to compensate for these shortcomings of the DSC, it was suggested that the DSC come equipped with an image/sound recording/reproducing apparatus such as a camcorder which records and reproduces image and sound of an object with respect to a recording media such as a tape, and the digital video camera (DVC) is the representative example of the same.

The DVC mainly includes a lens device, a signal converter, a deck device to record/reproduce captured images, and a display. The DVC usually uses a cassette tape as a recording medium, and therefore, the cassette tape is usually mounted on a deck device to record the motion picture as captured. Additionally, the DVC is provided with a microphone device and a speaker device, and is capable of photographing with the cassette tape for more than 1 hour. The DVC can also photograph still images. However, because it has a degraded image quality when compared to the DSC, the DVC is used mainly for capturing motion pictures. Further, because the DVC has more complex functions and construction than DSC, the DVC is usually larger in size and is more expensive than the DSC.

Accordingly, in order to photograph motion pictures as well as still images, a customer usually purchases a DSC and DVC individually. As a result, the customer has a budget problem because he/she has to buy two expensive devices altogether. Furthermore, the customer has to carry both a DSC and a DVC to use them.

In an effort to resolve the problems mentioned above, an integrated DSC/DVC, or digital camera/camcorder (so-called ‘DUOCAM’) in which a DSC and a DVC are integrated into a single casing, has been developed.

The DUOCAM uses both the memory card and the magnetic tape as a recording media, i.e., to store still images or motion pictures, and accordingly, the user may select either of the two to record the images he/she is photographing. The memory card has an advantage that it is compact-sized and can directly connect to the PC to thus enable easy transmission of data. However, the memory card has a relatively small memory capacity. The magnetic tape has a large memory capacity, but cannot compare to the memory card when it comes to compactness and data transmission efficiency. Accordingly, from the view of space utilization, it is more efficient to store low resolution images on the memory card, i.e., the data with a small volume onto the memory card, while images of high resolution are stored on the magnetic tape which has a relatively large memory capacity. As described above, the DUOCAM needs a function to automatically select the resolution of the recording images in accordance with the recording medium selection by the user. Otherwise, the user has to select the resolution in addition to the recording medium, which could be quite cumbersome.

### SUMMARY OF THE INVENTION

The above disadvantages are overcome and other advantages realized by embodiments of the present invention. Embodiments of the present invention comprise a plurality of different recording media, one of which is selected by a media selector to record the photographed image. The photographed image is stored at a lower resolution if the media selector selects a first recording medium and, if the media selector selects a second recording medium, the photographed image is stored at a higher resolution. Additional embodiments of the present invention comprise the steps of selecting the medium on which to record the photographed image from a plurality of recording media, a storing the photographed image at a lower resolution if a first recording medium is selected in the selecting step, and storing the photographed image at a higher resolution if a second recording medium is selected in the selecting step.

### BRIEF DESCRIPTION OF THE DRAWINGS

The above aspects and features of the present invention will be more apparent by describing certain embodiments of the present invention with reference to the accompanying drawing figures, in which:

FIG. 1 is a perspective view of a photographing apparatus constructed according to an embodiment of the present invention;

FIG. 2 is a block diagram showing a photographing apparatus constructed according to a preferred embodiment of the present invention;

FIGS. 3A to 3E are views for the explanation of a complex camera unit constructed according to an embodiment of the present invention;

FIGS. 4A and 4B are views for the explanation of a DSC resolution selecting unit according to an embodiment of the present invention;

FIGS. 5A and 5B are views for the explanation of a recording medium setting unit according to an embodiment of the present invention;

FIGS. 6 to 10 are views for the explanation of a mode selection switch unit according to an embodiment of the present invention; and

FIG. 11 is a flowchart for the explanation of the photographing method according to an embodiment of the present invention.

### DETAILED DESCRIPTION OF THE PREFERRED EMBODIMENTS

Certain embodiments of the present invention will now be described in greater detail with reference to the accompanying drawings.

In the following description, it should be understood that the same drawing reference numerals are used for the same elements even in different drawings. The matters defined in the description such as a detailed construction and elements are provided to assist in a comprehensive understanding of the invention, and are not meant to be limiting. Thus, it is apparent that the present invention can be carried out without those defined matters. Also, well-known functions or constructions are not described in detail since they would obscure the invention in unnecessary detail.

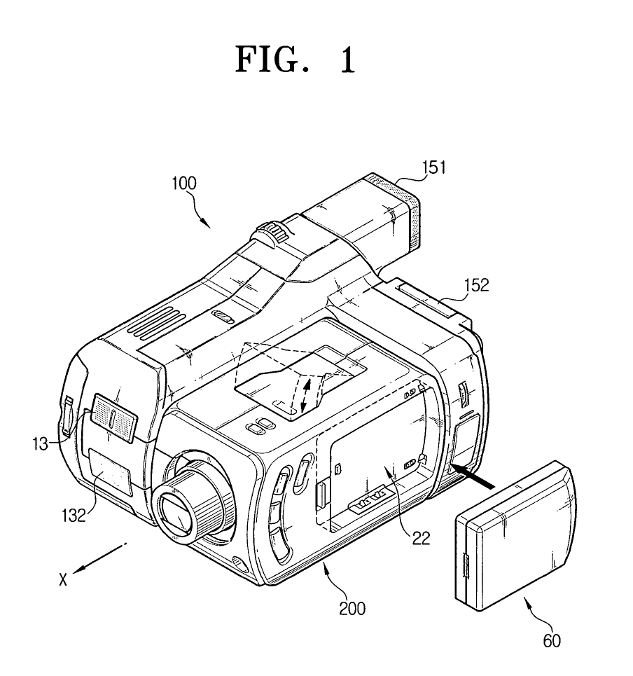

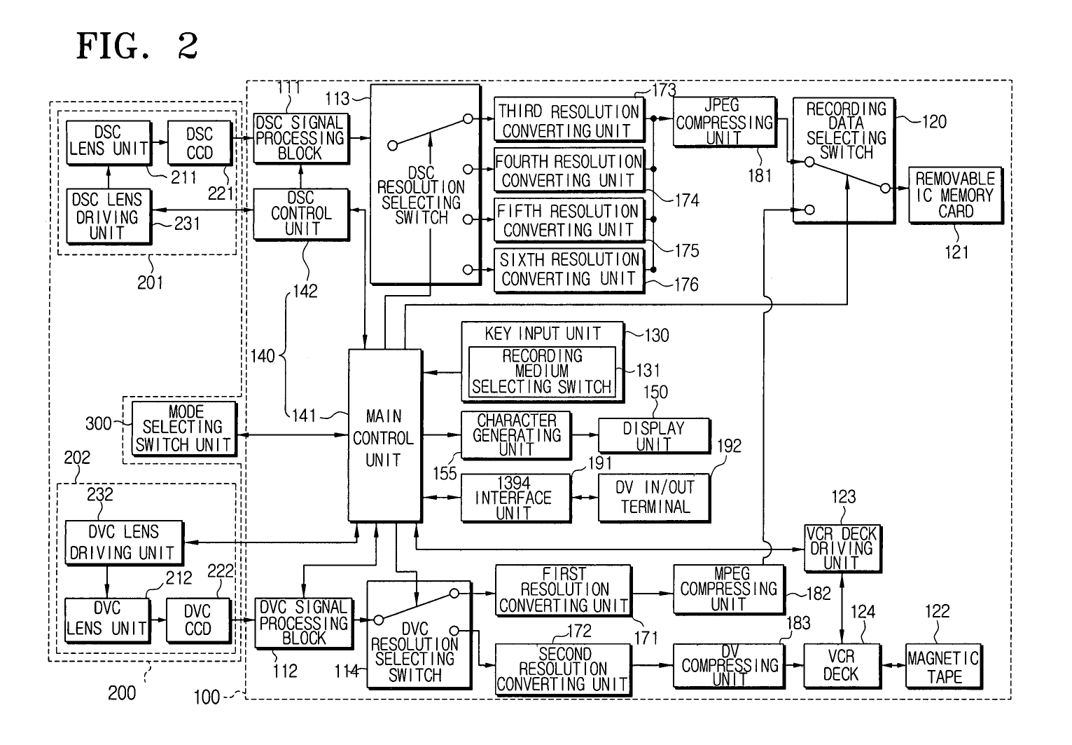

FIG. 1 is a perspective view of a photographing apparatus according to an embodiment of the present invention. FIG. 2 is a block diagram of the photographing apparatus. Referring to FIGS. 1 and 2, the photographing apparatus includes a main body 100, a complex camera unit 200 connected to the main body 100 and a mode selection switch unit 300.

Referring to FIG. 2, the complex camera unit 200 includes a digital still camera (DSC) unit 201, and a digital video camera (DVC) unit 202. The DSC unit 201 and the DVC unit 202 are for different image types, and therefore, they are driven independently from each other. The DSC unit 201 includes a DSC lens unit 211, a DSC CCD 221 and a DSC lens driving unit 231, and the DVC unit 202 includes a DVC lens unit 212, a DVC CCD 222 and a DVC lens driving unit 232.

The DSC lens driving unit 231 drives the DSC lens unit 211 according to the control of the DSC control unit 142. An optical image, which is converged through the DSC lens unit 211, is photoelectrically converted into electric signals at the DSC CCD 221, and the converted signals are transmitted to the DSC signal processing block 111. The DSC CCD 221 preferably uses progressive scanning.

The DVC lens driving unit 232 drives the DVS lens unit 212 according to the control of the main control unit 141. An optical image, which is converged through the DVC lens unit 212, is photoelectrically converted into electric signals at the DVC CCD 222, and the converted signals are transmitted to the DVC signal processing block 112. The DVC CCD 222 preferably uses interlace scanning.

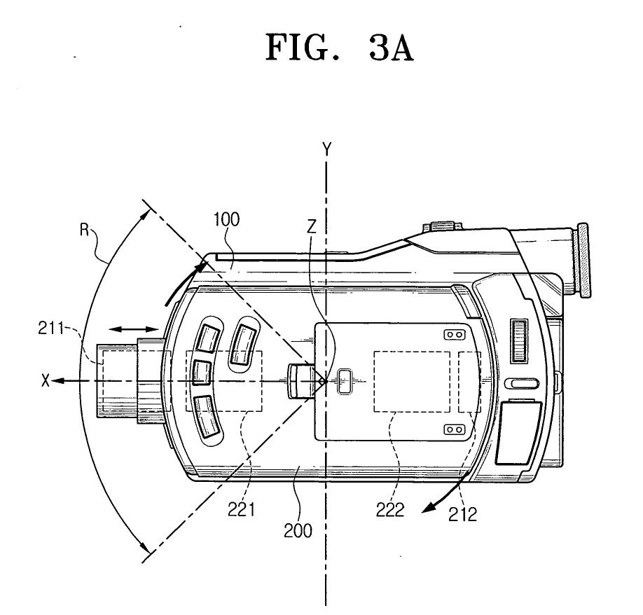

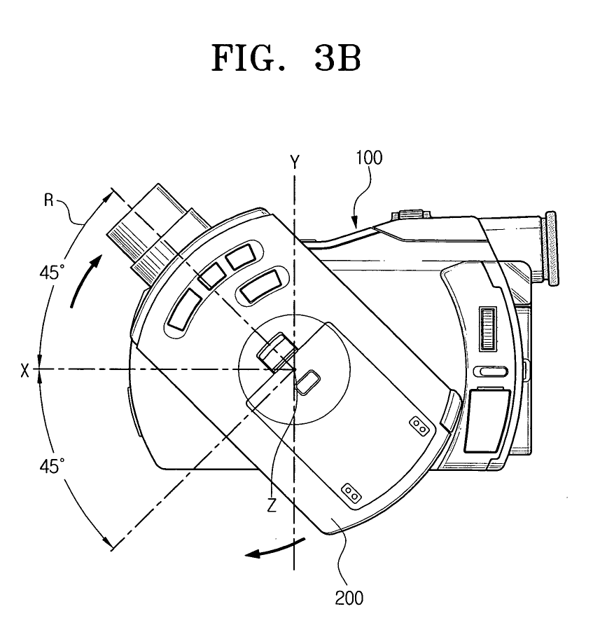

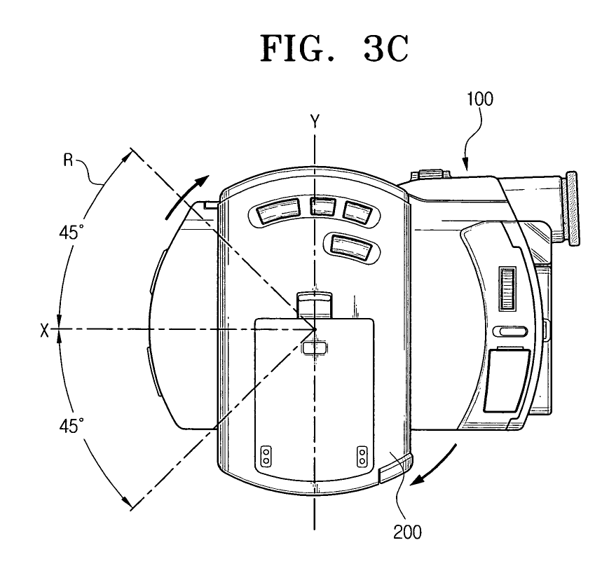

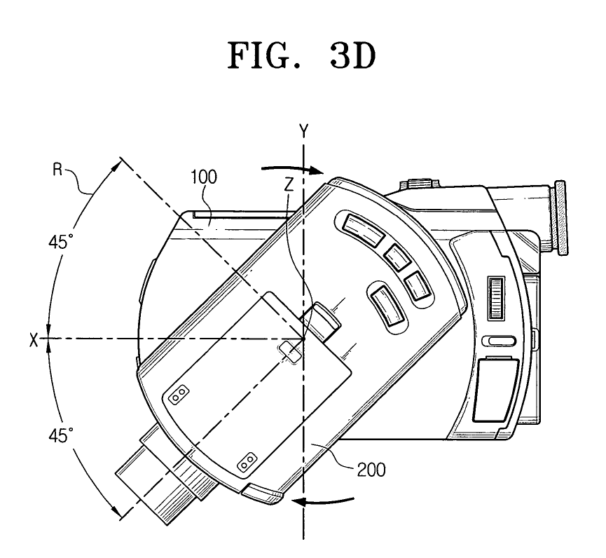

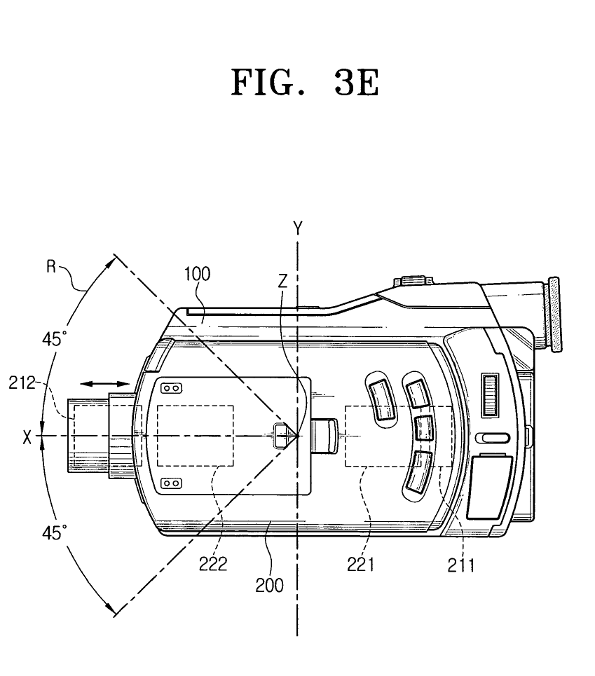

FIGS. 3A to 3E are views for the explanation of the complex camera unit 200. The complex camera unit 200 is mounted such that, according to rotating manipulation by the user, the complex camera unit 200 turns about a Z axis to more than about 180° from the side view of the main body 100. According to the rotation angle of the complex camera unit 200 with respect to the main body 100, one of the DSC unit 201 and the DVC unit 202 of the complex camera unit 200 performs photographing. More specifically, the camera unit, which is positioned within the vertical angle of 45° with reference to the left side of the X axis, performs the photographing.

FIGS. 3A to 3E show the position of the complex camera unit 200 according to the rotation of the complex camera unit 200 by 45° increments in the clockwise direction. Referring to FIG. 3A, the elements in the dotted lines respectively represent the DSC lens unit 211, the DSC CCD 221, the DVC lens unit 212 and the DVC CCD 222, which are installed inside the complex camera unit 200, and for the convenience in explanation, the DSC lens driving unit 231 and the DVC lens driving unit 232 are omitted from the drawing. Referring to FIGS. 3A and 3B, the DSC is in an operation mode in which the DSC unit 201 performs the photographing, because the DSC lens unit 211 and the DSC CCD 221 are positioned within the vertical angle R of 45° with reference to the left side of the X axis. Referring to FIG. 3C, there is no camera unit positioned within the vertical angle R of 45° with reference to the left side of the X axis. Accordingly, neither camera unit si positioned to perform the photographing.

Referring to FIGS. 3D and 3E, the DVC lens unit 212 and the DVC CCD 222 are positioned within the vertical angle R of 45° with reference to the left side of the X axis. Accordingly, the DVC unit 202, which is positioned within the vertical angle R of 45° with reference to the left side of the X axis, performs the photographing.

Referring to FIGS. 1 and 2, the main body 100 of the photographing apparatus may house respective components of the photographing apparatus, except the components of the complex camera unit 200 and the mode selection switch unit 300.

The DSC signal processing block 111 processes the signals from the DSC CCD 221 in frame unit, and outputs digital still image data. According to the control of the DSC control unit 142, the DSC signal processing block 111 may modify color, color depth, color brightness and shutter speed during photographing.

There is a third resolution converting unit 173 provided to convert the digital still image data received from the DSC signal processing block 111 to 2272×1704 resolution. Also, there are a fourth resolution converting unit 174 to convert the digital still image data to 2272×1504 resolution, and a fifth resolution converting unit 174 to convert to 1600×1200 resolution, and a sixth resolution converting unit to convert to 640×480 resolution.

A JPEG compression unit 181 compresses the data received from the third through sixth resolution converting units 173 through 176 to JPEG format. The JPEG data is stored on a removable IC memory card 121.

The DVC signal processing block 112 processes the received signals from the DVC CCD 222 in a field unit, and outputs the digital motion picture data. According to the control by the main control unit 141, the DVC signal processing block 112 can modify the color, color depth, color brightness and shutter speed.

A first resolution converting unit 171 converts the digital motion picture data received from the DVC signal processing block 112 to 320×240 resolution. A MPEG compression unit 182 compresses the received data from the first resolution converting unit 171 to MPEG format data. The MPEG format data are stored to a removable IC memory card 121.

Meanwhile, a second resolution converting unit 172 converts the received digital motion picture data from the DVC signal processing block 112 to 740×480 resolution. A DV compression unit 183 compresses the received data from the second resolution converting unit 172 to DV format data, and the DV format data are stored to the magnetic tape 122 via a VCR deck 124.

Referring to FIG. 1, a speaker 13 to output reproduced sound, and a microphone 132 to acquire external sound are provided at the rear of the main body 100 which is facing in the photographing direction ‘X’.

As for the recording medium shown in FIG. 2, there are a removable IC memory card 121 and a magnetic tape 122. The removable IC memory card 121 can directly connect to the PC and thus enables easy data transmission. However, having relatively small memory capacity, the IC memory card 121 is usually used for the storage of small-volume of data. The IC memory card 121 is one type of recording medium, which is usually formed as a card. The IC memory card 121 has one or more semiconductor memories contained in the casing, and an interface connector provided at an end which is usually used to expand memory capacity. The IC memory card 121 can be categorized depending on the type of the memories contained therein, such as a RAM card, a flash memory card and a non-volatile semiconductor memory card. Meanwhile, the magnetic tape 122 is inserted in the VCR deck 124 which is driven by the VCR deck driving unit 123, and has a larger memory capacity than the removable IC memory card 121.

A character generating unit 155 receives a control signal from the main control unit 141, and accordingly generates certain letters on corresponding positions on the display unit 150.

An IEEE 1394 interface unit 191 is used to exchange data with other external devices, and is usually used for interfacing with a PC. In other words, the digital image data can be transmitted to the PC via the IEEE-1394 interface unit 191, and the digital image data can also be recorded from the PC to the magnetic tape 122.

Referring back to FIG. 1, the display unit 150 includes a view finder 151 which is provided to the main body 100 to display image as captured, and a LCD panel 152 which is also provided to the main body 100.

Still images, captured by the DSC, are stored on the removable IC memory card 121. The user uses a DSC resolution selecting unit (not shown), and therefore, is enabled to select the resolution for the still images being stored. At higher resolutions, the data size increases and thus, the number of storable photos decreases. With the lower resolution, the data size decreases, and therefore, the number of storable photo increases. For example, when the storage capacity of the removable IC memory card 121 is 32 MB and the resolution is 2272×1704, approximately 52 photos can be stored. With the resolution at 640×480, approximately 360 photos can be stored.

The DSC resolution selecting unit may be formed to include a key input unit 130, a character generating unit 155 and a display unit 150. The key input unit 130 is provided with a menu key for inputting a command to display menu screen on the display unit, a direction key for moving a cursor with respect to the items selectively arranged on the menu screen, and a selection key for selecting the item where the cursor is placed. With the user pressing on the menu key, the key input unit 130 transmits a menu display signal to the main control unit 141. Likewise, if the user presses on the direction key, the key input unit 130 transmits a cursor moving signal to the main control unit 141, and the key input unit 130 transmits an item selection signal with the pressing of the selection key. The main control unit 141 in receipt of the menu display signal controls the character generating unit 155, which displays a menu screen on the display unit 150. Upon receiving the cursor moving signal, the main control unit 141 controls the character generating unit 155 indicates that the cursor has moved on the display unit 150. Meanwhile, the main control unit 141 in receipt of the item selection signal controls the character generating unit 155 to indicate a sub-menu of the item on the display unit, and in the absence of sub-menu, the main control unit 141 controls the operations corresponding to the menu items.

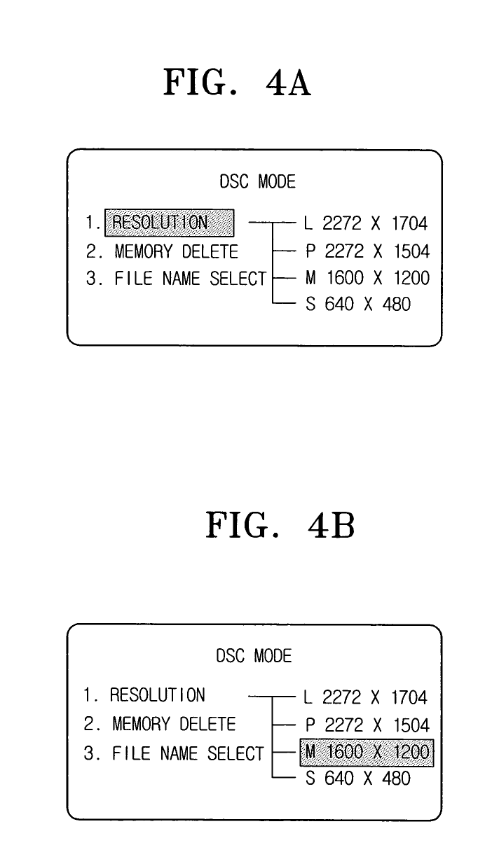

FIGS. 4A and 4B are views for illustrating the process of selecting a DSC resolution using a menu screen. As shown in FIG. 4A, as the user presses the menu display key while the photographing apparatus is operated in DSC operation mode, the DSC menu screen is displayed on the display unit. Additionally, with the placing of cursor on the item of ‘1. resolution’ and pressing a selection key, the sub-menu of the item ‘1. resolution’, i.e., ‘(1) L2272×1704’, ‘(2) P2272×1504’, ‘(3) M1600×1200’ and ‘(4) S640×480’ is displayed. As shown in FIG. 4B, when the user uses the direction key to place the cursor on the sub-item ‘(3) M1600×1200’ and presses the selection key, the main control unit 141 controls such that the still image data are converted to 1600×1200 resolution.

Meanwhile, the motion pictures captured by the DVC are selectively stored to the removable IC memory card 121 or the magnetic tape 122, along the storage path that is set by the user as he/she likes. In other words, the recording medium selecting switch 131 outputs a memory recording mode signal or a tape recording mode signal to the main control unit 141 in accordance with the selection made by the user.

The user may select a recording medium through a recording medium setting unit (not shown), which includes the key input unit 130, the character generating unit 155 and the display unit 150. The functions of the respective parts are identical to those as described above in the description of the DSC resolution selecting unit.

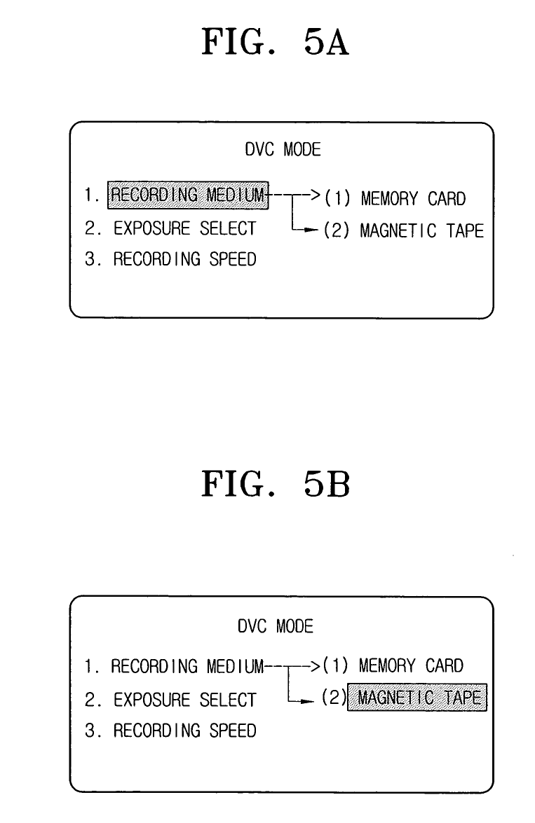

FIGS. 5A and 5B are views for illustrating the process of setting a recording medium, using a menu screen. As shown in FIG. 5A, as the user presses on the menu display key while the photographing apparatus is operated in the DVC operation mode, the DVC menu screen is displayed on the display unit 150. As the user places the cursor on the item of ‘1. recording medium’ and presses the selection key, the sub-menu of the ‘1. recording medium’, i.e., ‘(1) memory card’ and ‘(2) magnetic tape’ is displayed. As shown in FIG. 5B, as the user places the cursor on the sub-item of ‘(2) magnetic tape’ and presses the selection key, the main control unit 141 sets a storage path along which the captured motion pictures are stored in the magnetic tape 122.

Referring again to FIG. 2, the main control unit 141 and the DSC control unit 142 constitutes a control unit 140. The main control unit 141 determines whether the current operation mode is DSC operation mode or the DVC operation mode, based on the operation mode signal received from the mode selection switch unit 300. The main control unit 141, if determining the DSC operation mode, controls the DSC control unit 142 so as to control the DSC lens driving unit 231 and the DSC signal processing block 111, respectively. Accordingly, the optical image converged through the DSC lens unit 211 is photoelectrically converted into electric signals at the DSC CCD 221, and the converted signals are converted into digital still image data at the DSC signal processing block 111. The main control unit 141 changes the resolution of the output digital still image data based on the signal received from the DSC resolution selecting unit. In other words, the main control unit 141 manipulates on the DSC resolution selecting switch 113 so that the output digital still image data from the DSC signal processing block 111 can be transmitted to any one of the third through sixth resolution converting units. The digital still image data being transmitted to the third resolution converting unit 173 is converted to 2272×1704 resolution, and the digital still image data being transmitted to the fourth resolution converting unit 174 is converted to 2272×1504 resolution. The digital still image data being transmitted to the fifth resolution converting unit 175 is converted to 1600×1200 resolution, and the digital still image data being transmitted to the sixth resolution converting unit 176 is converted to 640×480 resolution. The converted data is compressed to JPEG format data at the JPEG compression unit 181. The main control unit 141 manipulates on the stored data selecting switch 120 so that the JPEG format data from the JPEG compression unit 181 can be stored in the removable IC memory card 121.

Meanwhile, the main control unit 141 determining the DVC operation mode controls the DVC lens driving unit 232 and the DVC signal processing block 112 so that the optical image converted through the DVC lens unit 212 can be photoelectrically converted to electric signals at the DVC CCD 222, and converted to digital motion picture data at the DVC signal processing block 112. Based on the recording mode signal received from the recording medium switch 131 or from the recording medium setting unit (not shown), the main control unit 141 determines whether the current recording mode is the memory recording mode or the tape recording mode. The main control unit 141 after determining the memory recording mode is the current recording mode manipulates the DVC resolution selecting switch 114 so that the digital motion picture data output from the DVC signal processing block 112 can be transmitted to the first resolution converting unit 171. The first resolution converting unit 171 converts the digital motion picture data to 320×240 resolution. The data output from the first resolution converting unit 171 is compressed to MPEG format data at the MPEG compressing unit 182. The main control unit 141 manipulates the recording data selecting switch 120 so that the MPEG format data can be stored in the removable IC memory card 121. The main control unit 141 after determining the tape recording mode is the current recording mode manipulates the DVC resolution selecting switch 114 so that the digital motion picture data output from the DVC signal processing block 112 can be transmitted to the second resolution converting unit 172. The second resolution converting unit 172 converts the digital motion picture data to 720×480 resolution. The data output from the second resolution converting unit 172 is compressed to DV format data at the DV compressing unit 183, and stored on the magnetic tape 122 through the VCR deck 124.

The mode selection switch unit 300 is installed such that it operates in association with the complex camera unit 200. The mode selection switch unit 300 outputs to the main control unit 141 an operation mode signal corresponding to the rotation angle of the complex camera unit 200, and the main control unit 141 determines the current operation mode with the received operation mode signal.

As shown in FIG. 3A, when the DSC lens unit 211 and the DSC CCD 221 are positioned within the vertical angle range of 45° with respect to the left side of the X axis, the mode selection switch unit 300 outputs the DSC operation mode signal to the main control unit 141 and the control unit 140 operates the DSC unit 201, while keeping the DVC unit 202 off.

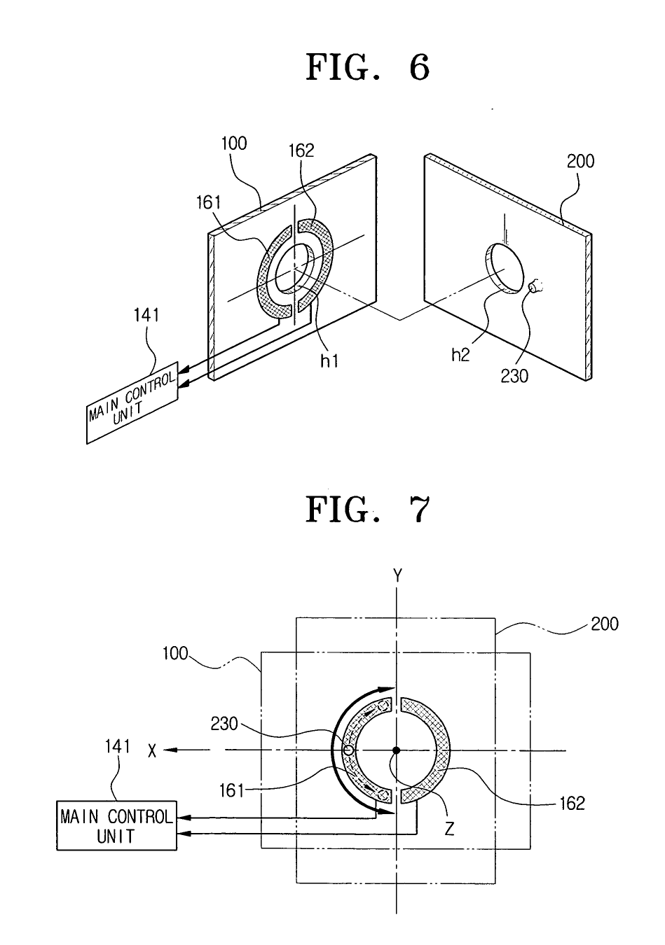

FIGS. 6 to 10 are views for the explanation of an exemplary mode selecting switch unit. FIG. 6 is a perspective view for explaining an exemplary mode selecting switch unit 300 of FIG. 2. Referring to FIG. 6, the switch may include first and second connection patterns 161, 162 provided on the main body 100, and a connection terminal 230 provided on the complex camera unit 200 to contact either one of the two connection patterns 161, 162. In the above-mentioned construction, the main body 100 and the complex camera unit 200 are connected, with facing holes h1 and h2, which rotate in relative to each other. Accordingly, in accordance with the rotation angle of the complex camera unit 200 with respect to the main body 100, the connection terminal 230 contacts either the first connection pattern 161 or the second connection pattern 162. The first connection pattern 161 is connected to a first port of the main control unit 141, and the second connection pattern 162 is connected to a second port of the main control unit 141.

FIG. 7 is a view illustrating the state where the DSC unit 201 is selected by the exemplary switch of FIG. 6. In this case, as the connection terminal 230 contacts the first connection pattern 161 as shown in FIG. 7. When the rotation angle of the complex camera unit 200 is within the vertical angle range of 90° with respect to the left side of the Y axis, a binary signal ‘1’ of the DSC operation mode signal for operating the DSC unit 201 is output to the first port of the main control unit 141. A binary signal ‘0’ is output to the second port of the main control unit 141. As a result, the DSC operation mode in which the DSC unit 201 takes the photographing is selected, and the control unit 140 operates the DSC unit 201 while keeping the DVC unit 202 off.

When the connection terminal 230 contacts the second connection pattern 162, after rotating the complex camera unit 200. The connection terminal 230 is within the vertical angle range of 90° with respect to the right side of the Y axis. At this position, a binary signal ‘1’ of DVC operation mode signal is output to the second port of the main control unit 141, and a binary signal ‘0’ is output to the first port of the main control unit 141.

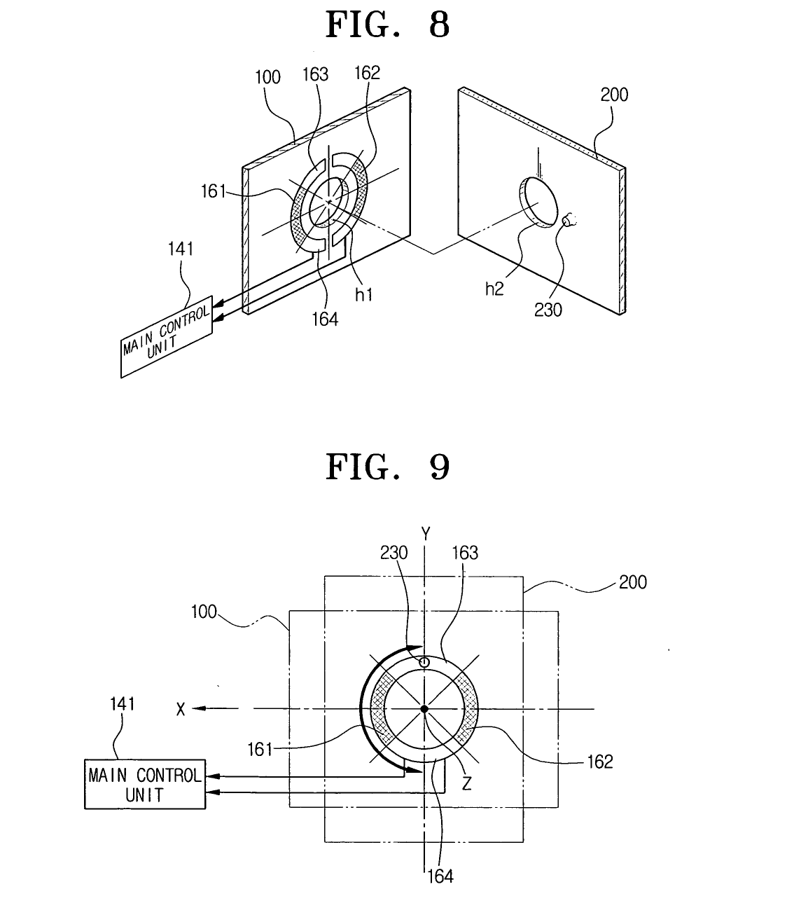

FIG. 8 is a perspective view for the explanation of an exemplary mode selection switch unit 300 of FIG. 2. The exemplary switch as shown in FIG. 8 further includes third 163 and fourth 164 connection patterns in addition to the first 161 and second 162 connection patterns of the main body 100. The exemplary switch 300 may further be constructed to include the connection terminal 230 which is provided on the complex camera unit 200 to contact one of the connection patterns 161 through 164. According to the rotation angle of the complex camera unit 200 with respect to the main body 100, the connection terminal 230 contacts one of the first 161 to fourth 164 connection patterns. The first connection pattern 161 is connected to the first port of the main control unit 141, the second connection pattern 162 to the second port, and the third 163 and the fourth 164 connection patterns are not connected to the ports of the main control unit 141.

FIG. 9 is a view illustrating the state where no camera unit is selected by the exemplary switch of FIG. 8. As shown in FIG. 9, as the connection terminal 230 contacts the third connection pattern 163, when the rotation angle of the complex camera unit 200 falls within a third range. This third range is contacted when the connection terminal 230 is within the horizontal angle range of 45° with respect to an upper side of Y axis origin. In this position, no operation mode signal is output to the ports of the main control unit 141. The same situation applies to the case where the connection terminal 230 contacts the fourth connection pattern 164. Accordingly, in the absence of operation mode signal, the control unit 140 turns of the camera unit, and therefore, neither the DSC unit 201, nor the DVC unit 202 is operated.

Here, it is assumed that the first to fourth connection patterns 161 to 164 are arranged at a 90° interval. In this case, when the connection terminal 230 is positioned within the vertical angle range of 45° with respect to the left side of the X axis, the DSC unit 201 is operated. When the connection terminal 230 is positioned within the vertical angle range of 45° with respect to the right side of the X axis, the DVC unit 202 is operated. No camera unit is operated if the connection terminal 230 is positioned within the horizontal angle range of 45° with respect to the upper or lower side of Y axis origin, the DSC unit 201 is operated. As described above, all the camera units are in an off state within the horizontal angle range of 45° with respect to the Y axis. This is to prevent an undesirable collision between the DSC 211 or the DVC 212 lens units with the main body 100 in case the user selects a zoom function and rotates the complex camera unit 200 with the DSC 211 and the DVC lens units 212 extending outside.

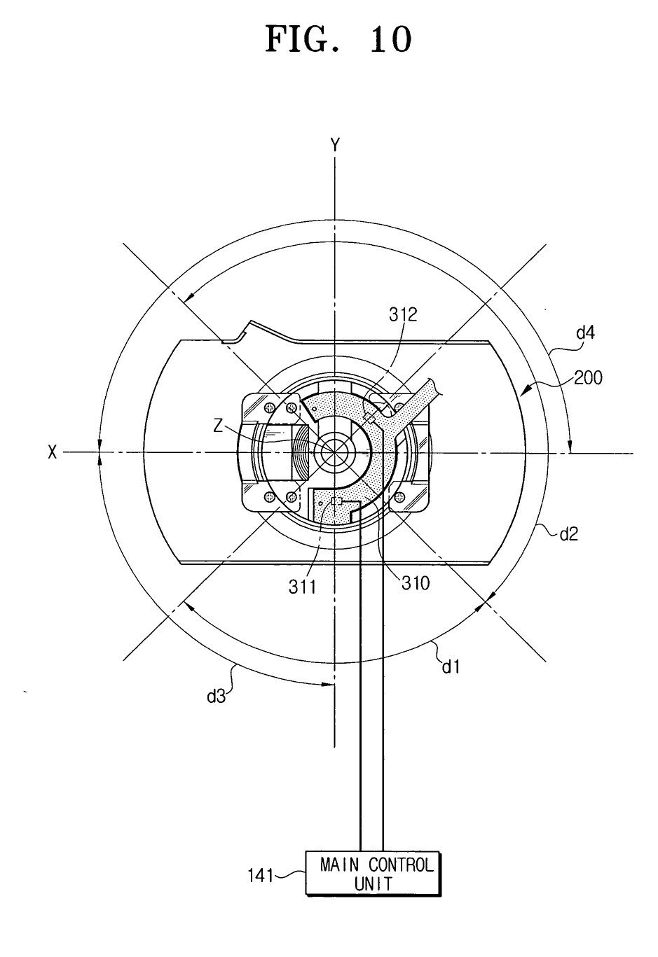

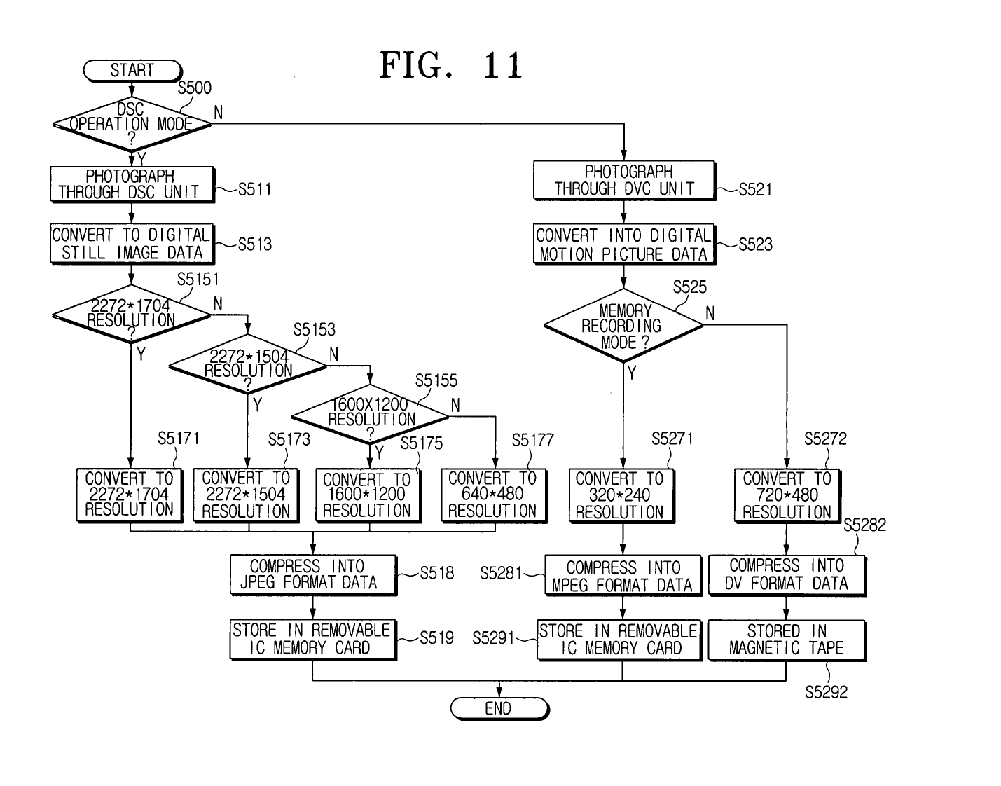

FIG. 10 is a view for the explanation of another example of the mode selection switch unit 300 of FIG. 2. Referring to FIG. 10, a mode switch unit 310 is provided to a contact surface between the complex camera unit 200 and the main body 100, and there are a DSC mode switch 311 and a DVC mode switch 312 provided to the mode switch unit 310. The DSC mode switch 311 is connected to the first port of the main control unit 141, and the DVC mode switch 312 is connected to the second port of the main control unit 141. As the complex camera unit 200 is rotated with respect to the main body 100, the mode switch unit 310, the DSC mode switch 311 and the DVC mode switch 312 are also rotated altogether.

The DSC mode switch 311 rotatably switches within the ranges d1 and d2. When the DSC mode switch 311 is positioned within the range d1, the horizontal angle range of 45° below the origin of Y axis, a binary signal ‘1’ of DSC operation mode signal to operate the DSC unit 201 is output to the first port of the main control unit 141. A binary signal ‘0’ is output to the second port of the main control unit 141. Meanwhile, the DVC mode switch 312 switches within the ranges d3 and d4. When the DVC mode switch 312 is positioned within the range d3, i.e., within the horizontal angle range of 90° with respect to the lower side of Y axis origin, a binary signal ‘1’ of DVC operation mode signal to operate the DVC unit 202 is output to the second port of the main control unit 141. A binary signal ‘0’ is output to the first port of the main control unit 141.

FIG. 11 is a flowchart illustrating the photographing method according to an embodiment of the present invention. Referring to FIG. 11, the main control unit 141 determines the operation mode based on the operation mode signal received from the mode selection switch unit 300 (S500).

When determining the DSC operation mode in S500, the DSC CCD 221 photoelectrically converts the optical image converged through the DSC lens unit 211 into electric signals, and transmits the converted signals to the DSC signal processing block 111 (S511). The DSC signal processing block 111 converts the signals to digital still image data (S513). Based on the signals received from the DSC resolution selecting unit, the main control unit 141 determines a desired resolution (S5151, S5153, S5155). The digital still image data, which is output from the DSC signal processing block 111, is converted to one resolution from among the resolutions of 2272×1704, 2272×1504, 1600×1200 and 640×480 (S5171, S5173, S5175, S5177). The JPEG compressing unit 181 compresses the converted data to JPEG format data (S518). The JPEG format data is stored to the removable IC memory card 121 (S519).

Meanwhile, when the DVC operation mode is determined in S500, the DVC CCD 222 photoelectrically converts the optical image converged through the DVC lens unit 212 into electric signals, transmits the signals to the DVC signal processing block 112 so that the DVC signal processing block 112 converts the received signals into digital motion picture data (S521, S523). Based on the recording mode signal received from the recording medium selecting switch 131 or the recording medium setting unit (not shown), the main control unit 141 determines the recording mode (S525). When it is determined to be a memory recording mode in S525, the digital motion picture data output from the DVC signal processing block 112 is converted to 320×240 resolution (S5271). The converted data are then compressed to MPEG format data at the MPEG compressing unit 182 (S5281). The MPEG format data are stored to the removable IC memory card 121 (S5291). Further, when it is determined to be the tape recording mode in S525, the digital motion picture data output from the DVC signal processing block 112 is converted to the 720×480 resolution (S5272). The converted data is compressed to digital video (DV) format data at the DV compressing unit 183 (S5282). Then the DV format data are stored to the magnetic tape via the VCR deck 124 (S5292).

As described above, according to an embodiment of the present invention, in storing the images to the photographing apparatus having a plurality of different recording media, the resolution is automatically selected depending on the user selection of the recording medium. That is, because the higher resolution is set for the recording medium with a large memory capacity, and the lower resolution is set for the recording medium with a smaller memory capacity, automatically, the user does not have to set the resolution every time he/she selects the recording medium to use.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

We claim:

1. A photographing apparatus comprising:
a plurality of different recording media;
a media selector that selects a specific medium from the plurality of different recording media on which to record the photographed image;
wherein the photographed image is stored at a lower resolution if the media selector selects a first recording medium; and
wherein the photographed image is stored at a higher resolution if the media selector selects a second recording medium.

2. A photographing apparatus of claim 1, further comprising:
a resolution selector to select a resolution from a plurality of resolutions at which to store the photographed image.

3. A photographing apparatus of claim 1, wherein said first recording medium is an integrated chip memory.

4. A photographing apparatus of claim 3, wherein said first recording medium is removable for said photographing apparatus.

5. A photographing apparatus of claim 1, wherein said second recording medium is a magnetic tape.

6. A method of setting the resolution of a photographed image comprising the steps of:
selecting the medium on which to record the photographed image from a plurality of recording media;
storing the photographed image at a lower resolution if a first recording medium is selected in the selecting step; and
storing the photographed image at a higher resolution if a second recording medium is selected in the selecting step.

7. A method of claim 6, further comprising the step of:
selecting a resolution from a plurality of resolutions at which to store the photographed image after the medium is selected.

8. A method of claim 6, wherein said first recording medium is an integrated chip memory.

9. A method of claim 8, wherein said first recording medium is removable for said photographing apparatus.

10. A method of claim 6, wherein said second recording medium is a magnetic tape.

11. A photographing apparatus, comprising:
a digital video camera for capturing motion picture data;
a digital still camera for capturing still picture data;
a media selector for selecting one of the plurality of different storage media to store picture data;
a resolution selector for selecting one of a plurality of resolution converting units based upon the storage medium selected by said media selector;
wherein each of said selected resolution converting units convert the picture data to a particular resolution; and
a controller for controlling storing the converted data on the selected storage medium.

12. A photographing apparatus of claim 11, wherein the plurality of different media comprise an integrated chip memory and a magnetic tape.

13. A photographing apparatus of claim 12, wherein the resolution converting unit selected by the resolution selector converts the picture data to a low resolution when the media selector selects the integrated chip memory as the storage medium.

14. A photographing apparatus of claim 12, wherein the resolution converting unit selected by the resolution selector converts the picture data to a high resolution when the media selector selects the magnetic tape as the storage medium.
